(19) United States
(12) Patent Application Publication
(10) Pub. No.: US 2026/0319647 A1
(43) Pub. Date: Oct. 15, 2026

(54) ELECTRONIC DEVICE AND OPERATING METHOD THEREOF

(71) Applicant: SAMSUNG ELECTRONICS CO., LTD., Suwon-si (KR)

(72) Inventors: Taegu KIM, Suwon-si (KR); Eunkyung LEE, Suwon-si (KR)

(73) Assignee: SAMSUNG ELECTRONICS CO., LTD., Suwon-si (KR)

(21) Appl. No.: 19/698,354

(22) Filed: Jun. 4, 2026

Related U.S. Application Data
(63) Continuation of application No. PCT/KR2024/018488, filed on Nov. 21, 2024.

(30) Foreign Application Priority Data
Dec. 5, 2023 (KR) 10-2023-0174852
Dec. 29, 2023 (KR) 10-2023-0196828

(51) Int. Cl. G06F 3/04845; G06F 3/01; G06F 3/16; G06T 7/292; G06V 20/20; H04N 5/76

(52) U.S. Cl. CPC G06F 3/04845; G06T 7/292; G06V 20/20; H04N 5/76; G06F 3/013; G06F 3/017; G06F 3/167; G06T 2200/24

(57) ABSTRACT

An operating method of an electronic device may include an operation of displaying image data captured by a camera in a first area of a display. The method may include identifying objects included in the first area. The method may include, on the basis of a user input including at least one of a gaze input, a speech input, and a gesture input, determining a target object to be controlled by a user among the objects. The method may include displaying the target object in a second area of the display. The second area may be overlaid on the first area. In the second area, image data corresponding to the target object may be streamed. The image data streamed in the second area may be controlled on the basis of a user input for the target object to an object control interface.

### CROSS-REFERENCE TO RELATED APPLICATIONS

This application is a continuation of International Application No. PCT/KR2024/018488, filed on Nov. 21, 2024, which is based on and claims priority to Korean Patent Application No. 10-2023-0174852, filed on Dec. 5, 2023, and Korean Patent Application No. 10-2023-0196828, filed on Dec. 29, 2023, the disclosures of which are incorporated by reference herein in their entireties.

### FIELD

The disclosure relates to an electronic device and an operating method of the electronic device.

### BACKGROUND

Augmented reality (AR) refers to presenting virtual images within a physical environment of the real world or presenting images of virtual objects together with real objects. An experience in which a user experiences AR using AR technology is referred to as an AR experience. The AR experience enables a user to perceive and sense a world that the user may not otherwise experience, thereby allowing a user experience to be expanded without boundaries between reality and virtual reality. In addition, by sharing an experience of a user who has directly obtained an AR experience in a real space with another user, the user experience of a particular user may be extended to other users without limitations of time and space.

Virtual reality (VR) refers to technology that fully immerses a user in a virtual environment instead of the real world. VR separates a user from the real world and transports the user into a virtual space, enabling the user to experience an environment that surrounds the user in 360 degrees within the virtual space. Similar to AR, VR is also being utilized in various fields with the advancement of modern technology, enabling new creative and innovative experiences. AR and VR are collectively referred to as extended reality (XR).

The above information may be presented as the related art to help with the understanding of the disclosure. No determination is made as to whether any of the above information is applicable as prior art with respect to the present disclosure.

### SUMMARY

In accordance with an aspect of the disclosure, an operating method of an electronic device, includes: displaying, on a first area of a display, image data captured by a camera; identifying objects in the first area; based on a user input including at least one of a gaze input, a voice input, or a gesture input, determining a target object that a user intends to control from among the objects; and displaying the target object on a second area of the display. The second area is overlaid on the first area. The second area is an area on which image data corresponding to the target object is streamed. The image data streamed on the second area is controlled based on the user input to an object control interface of the target object.

The user input may include at least one of: first information used to determine the target object; or second information associated with at least one of display, recording, or sharing of the target object. The user input for providing the first information and the user input for providing the second information may have different input types.

The user input may include second information associated with at least one of display, recording, or sharing of the target object. The displaying of the target object on the second area may include: determining a reference point of the target object; determining a size and a position of the second area based on the reference point and second information; and displaying the target object on the second area having the determined size and position. The reference point corresponds to coordinates of a central pixel at a lowest position among pixels in the target object.

The determining of the size and the position of the second area may include: displaying a size selection guide for the target object on the first area; and determining the size of the second area based on an input of the user to the size selection guide.

Based on another object, other than the target object, being identified in the first area, the size selection guide may be generated based on a size of the other object. Based on no other object, other than the target object, being identified in the first area, the size selection guide may be generated based on a predetermined setting value.

Based on information regarding another object, other than the target object, being identified in the first area, the position of the second area may be determined so as not to overlap with the other object in the first area.

The target object may include a plurality of target objects. The second area may include a plurality of second areas on which image data corresponding to any one of the plurality of target objects is streamed. Positions of the plurality of second areas may be determined so as not to overlap with objects, other than the plurality of target objects, in the first area.

The image data streamed on the second area may be recorded in the electronic device based on the target object being determined.

Based on the camera being a single camera, the target object may not be displayed on the second area while the target object is not identified in the image data captured by the camera, and based on the camera including a plurality of cameras, the target object may be tracked by any one of the plurality of cameras, such that image data corresponding to the target object is continuously streamed on the second area.

The operating method may further include at least one of: adjusting at least one of a position or a size of the second area based on a subsequent input of the user to the object control interface; updating whether recording is to be performed for the second area based on the subsequent input; or performing sharing for the second area based on the subsequent input. The object control interface may be associated with display, recording, and sharing of the target object.

In accordance with an aspect of the disclosure, an electronic device includes: a display; one or more processors; and memory storing instructions. The instructions, when executed by the one or more processors individually or collectively, cause the electronic device to: display, on a first area of the display, image data captured by a camera; identify objects included in the first area; based on a user input including at least one of a gaze input, a voice input, or a gesture input, determine a target object that a user intends to control from among the objects; and display the target object on a second area of the display. The second area is overlaid on the first area. The second area is an area on which image data corresponding to the target object is streamed. The image data streamed on the second area is controlled based on the user input to an object control interface of the target object.

The user input may include at least one of: first information used to determine the target object; or second information associated with at least one of display, recording, or sharing of the target object. The user input for providing the first information and the user input for providing the second information have different input types.

The image data streamed on the second area may be recorded in the electronic device based on the target object being determined.

Based on the camera being a single camera, the target object may not be displayed on the second area while the target object is not identified in image data captured by the camera, and based on the camera including a plurality of cameras, the target object may be tracked by any one of the plurality of cameras, such that image data corresponding to the target object is continuously streamed on the second area.

The user input may include second information associated with at least one of display, recording, or sharing of the target object. The instructions, when executed by the one or more processors individually or collectively, cause the electronic device to: determine a reference point of the target object; determine a size and a position of the second area based on the reference point and the second information; and display the target object on the second area having the determined size and position. The reference point corresponds to coordinates of a central pixel at a lowest position among pixels in the target object.

### BRIEF DESCRIPTION OF DRAWINGS

The above and other aspects, features and advantages of certain embodiments will be more apparent from the following description taken in conjunction with the accompanying drawings, in which:

FIG. 1 is a block diagram illustrating an electronic device in a network environment according to an embodiment.

FIG. 2 is a perspective view illustrating an internal configuration of a wearable electronic device according to an embodiment.

FIGS. 3A and 3B are diagrams illustrating the front surface and the rear surface of a wearable electronic device according to an embodiment.

FIG. 4 is a schematic block diagram of an electronic device according to an embodiment.

FIG. 5 is a diagram illustrating object identification according to an embodiment.

FIGS. 6A and 6B are diagrams illustrating determination of a target object according to an embodiment.

FIG. 7 is a diagram illustrating an object control interface for controlling a target object, according to an embodiment.

FIGS. 8 and 9 are diagrams illustrating a method of displaying a target object on a display based on a reference point, according to an embodiment.

FIGS. 10A and 10B are diagrams illustrating a size selection guide for a target object, according to an embodiment.

FIG. 11 is a diagram illustrating a case in which a plurality of target objects is provided, according to an embodiment.

FIG. 12 is a diagram illustrating a case in which a plurality of cameras is provided, according to an embodiment.

FIG. 13 is a diagram illustrating a case in which an environment in which a target object is displayed changes, according to an embodiment.

FIG. 14 is a flowchart of an operating method of an electronic device, according to an embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto is omitted.

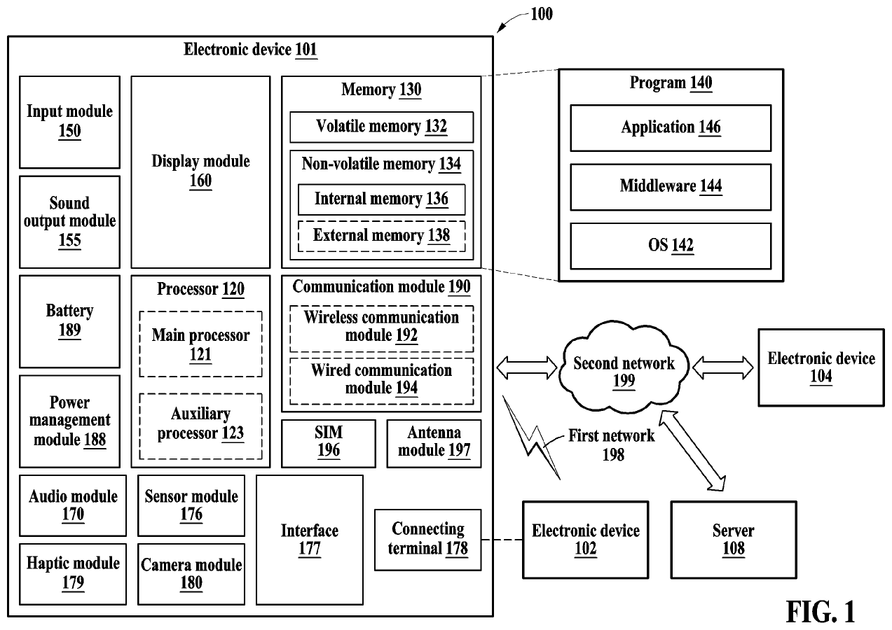

FIG. 1 is a block diagram illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a network 199 (e.g., a long-range wireless communication network). According to an embodiment, the electronic device 101 may communicate with the electronic device 104 via the server 108. According to an embodiment, the electronic device 101 may include at least one processor 120 (hereinafter, “the processor”), memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of data processing or computation, the processor 120 may store a command or data received from another component (e.g., the sensor module 176 or the communication module 190) in volatile memory 132, process the command or the data stored in the volatile memory 132, and store resulting data in non-volatile memory 134.

According to an embodiment, the processor 120 may be implemented as circuitry (e.g., processing circuitry) such as a system on chip (SoC) or an integrated circuit (IC). The processor 120 may include one or more processors. For example, the processor 120 may include a combination of one or more processors, such as a central processing unit (CPU), a graphics processing unit (GPU), a microprocessor unit (MPU), an application processor (AP), and a communication processor (CP).

According to an embodiment, the processor 120 may include a main processor 121 (e.g., a CPU or an AP), or an auxiliary processor 123 (e.g., a GPU, a neural processing unit (NPU), an image signal processor (ISP), a sensor hub processor, or a CP) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the NPU) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a CNN, a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto.

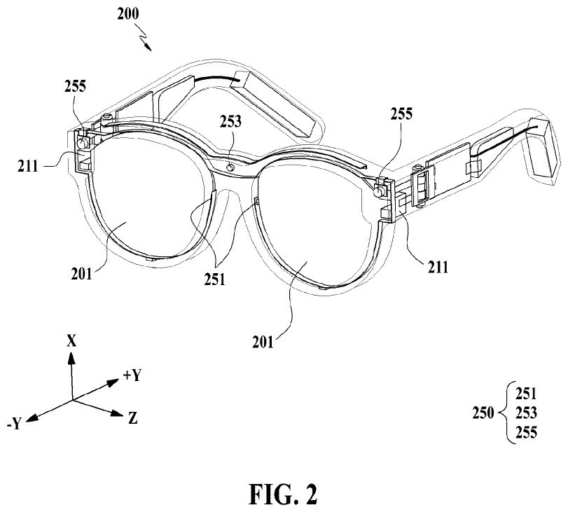

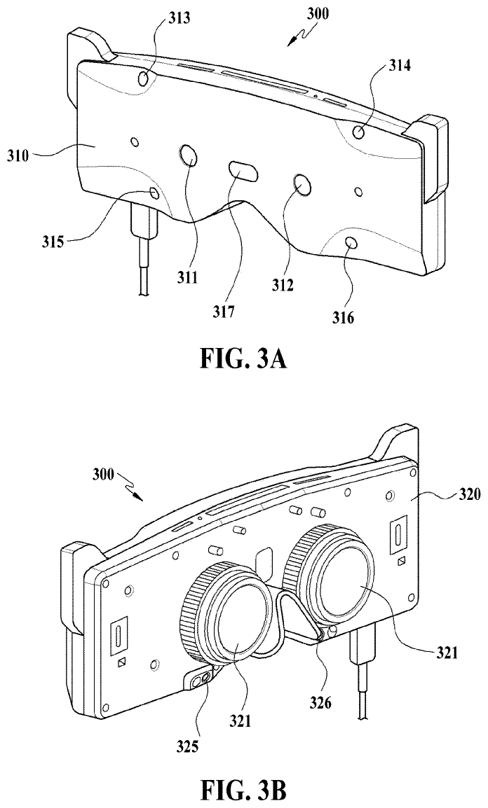

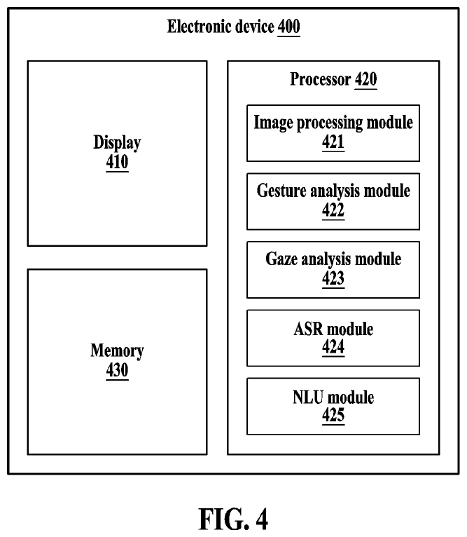

According to an embodiment, the memory 130 may include one or more memories. Instructions stored in the memory 130 may be stored in a single memory. The instructions stored in the memory 130 may be divided and stored in a plurality of memories. The instructions stored in the memory 130, when executed by the processor 120 individually or collectively, may cause the electronic device 101 (e.g., the electronic device 200 of FIG. 2 or the electronic device 300 of FIG. 3, or the electronic device 400 of FIG. 4) to perform and/or control a method described with reference to FIGS. 2 to 14. The instructions stored in the memory 130, when executed by a plurality of processors individually or collectively, may cause the electronic device 101 (e.g., the electronic device 200 of FIG. 2, the electronic device 300 of FIG. 3, or the electronic device 400 of FIG. 4) to perform and/or control the method described with reference to FIGS. 2 to 14. According to an embodiment, the memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., the electronic device 102) (e.g., a speaker or headphones) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a depth sensor, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 2 is a perspective view illustrating an internal configuration of a wearable electronic device according to an embodiment.

Referring to FIG. 2, a wearable electronic device 200 according to an embodiment may include at least one of a light output module 211, a display member 201, and a camera module 250. An electronic device (e.g., the electronic device 101 of FIG. 1) may be implemented in the form of the wearable electronic device 200. The wearable electronic device 200 (e.g., the electronic device 102 of FIG. 1) may be implemented separately from the electronic device (e.g., the electronic device 101 of FIG. 1). The wearable electronic device 200 (e.g., the electronic device 102 of FIG. 1) may be connected to the electronic device (e.g., the electronic device 101 of FIG. 1).

According to an embodiment, the light output module 211 may include a light source to output an image and a lens to guide an image to the display member 201. The light output module 211 may include at least one of a liquid crystal display (LCD), a digital mirror device (DMD), a liquid crystal on silicon (LCoS), an organic light-emitting diode (OLED), or a micro light-emitting diode (micro-LED).

According to an embodiment, the display member 201 may include an optical waveguide (e.g., a waveguide). An image output by the light output module 211 incident on one end of the optical waveguide may be propagated inside the optical waveguide and provided to the user. The optical waveguide may include at least one of diffractive elements (e.g., a diffractive optical element (DOE) and a holographic optical element (HOE)) or at least one of reflective elements (e.g., a reflection mirror). For example, the optical waveguide may guide the image output by the light output module 211 to the eyes of the user using the at least one diffractive element or the reflective element.

According to an embodiment, the camera module 250 may capture a still image and/or moving images. The camera module 250 may be disposed within a lens frame and disposed around the display member 201. The camera module 250 may include a first camera module 251, a second camera module 253, and a third camera module 255.

According to an embodiment, the first camera module 251 may capture and/or recognize the trajectory of a gaze or eye (e.g., a pupil or an iris) of the user. The first camera module 251 may periodically or irregularly transmit information (e.g., trajectory information) associated with the trajectory of the gaze or eye of the user to a processor (e.g., the processor 120 of FIG. 1).

According to an embodiment, the second camera module 253 may capture an external image.

According to an embodiment, the third camera module 255 may be used for hand detection and tracking and for recognition of a gesture (e.g., a hand gesture) of the user. The third camera module 255 may be used for three degrees of freedom (3 DoF) and 6 DoF head tracking, position (space or environment) recognition, and/or movement recognition. The second camera module 253 may be used for hand detection and tracking and for recognition of a gesture of the user. At least one of the first camera module 251 to the third camera module 255 may be replaced by a sensor module (e.g., a light detection and ranging (LiDAR) sensor). For example, the sensor module may include at least one of a vertical-cavity surface-emitting laser (VCSEL), an infrared sensor, and/or a photodiode.

FIGS. 3A and 3B are diagrams illustrating the front surface and the rear surface of a wearable electronic device 300 according to an embodiment.

Referring to FIGS. 3A and 3B, according to an embodiment, an electronic device (e.g., the electronic device 101 of FIG. 1) may be implemented in the form of the wearable electronic device 300. Camera modules 311, 312, 313, 314, 315, and 316 (e.g., the camera module 180 of FIG. 1) and/or a depth sensor 317 (e.g., the sensor module 176 of FIG. 1) for obtaining information related to the surrounding environment of the wearable electronic device 300 may be disposed on a first surface 310 of a housing.

According to an embodiment, the camera modules 311 and 312 may obtain an image related to the surrounding environment of the wearable electronic device 300.

According to an embodiment, the camera modules 313, 314, 315, and 316 may obtain an image in a state in which the wearable electronic device is worn by a user. The camera modules 313, 314, 315, and 316 may be used for hand detection and tracking and for recognition of a gesture (e.g., a hand gesture) of the user. The camera modules 313, 314, 315, and 316 may be used for 3 DoF and 6 DoF head tracking, position (space or environment) recognition, and/or movement recognition. The camera modules 311 and 312 may be used for hand detection and tracking and for recognition of a gesture of the user.

According to an embodiment, the depth sensor 317 may be configured to transmit a signal and receive a signal reflected from a subject and may be used to determine a distance to an object based on a time of flight (TOF) scheme. Instead of or in addition to the depth sensor 317, the camera modules 313, 314, 315, and 316 may determine a distance from an object.

According to an embodiment, camera modules 325 and 326 for face recognition (e.g., the camera module 180 of FIG. 1) and/or a display 321 (e.g., the display module 160 of FIG. 1) (and/or a lens) may be disposed on a second surface 320 of the housing.

According to an embodiment, the camera modules 325 and 326 for face recognition adjacent to a display may be used to recognize the face of the user or may recognize and/or track both eyes of the user.

According to an embodiment, the display 321 (and/or a lens) may be disposed on the second surface 320 of the wearable electronic device 300. The wearable electronic device 300 may not include the camera modules 315 and 316 among the plurality of camera modules 313, 314, 315, and 316. The wearable electronic device 300 may further include at least one component among the components shown in FIG. 2.

As described above, according to an embodiment, the wearable electronic device 300 may have a form factor to be worn on the head of the user. The wearable electronic device 300 may further include a wearing member and/or a strap to be fixed onto a body part of the user. The wearable electronic device 300 in a state of being worn on the head of the user may provide a user experience based on augmented reality (AR), virtual reality (VR), and/or mixed reality (MR).

FIG. 4 is a schematic block diagram of an electronic device according to an embodiment.

Referring to FIG. 4, according to an embodiment, an electronic device 400 may include at least some components of the electronic device 101 described with reference to FIG. 1. The electronic device 400 may be implemented in the form of a wearable electronic device (e.g., the wearable electronic device 200 of FIG. 2) (e.g., smart glasses including VR glasses). The electronic device 400 may be implemented in the form of a wearable electronic device (e.g., the wearable electronic device 300 of FIG. 3) (e.g., a head-mounted display (HMD) including an AR device, a VR device, and/or an MR device). The electronic device 400 may be configured to easily control a user interface (UI) component provided in AR and VR environments.

According to an embodiment, the electronic device 400 may control a target object displayed on a display 410 (e.g., the display module 160 of FIG. 1, the display member 201 of FIG. 2, or the display 321 of FIG. 3). For example, the electronic device 400 may display (e.g., stream) a target object on a second area of the display 410, and image data streamed (e.g., image display, video playback, real-time playback) on the second area may be controlled based on a user input to an object control interface associated with the display, recording, and sharing of the target object.

According to an embodiment, the electronic device 400 may include the display 410 (e.g., the display module 160 of FIG. 1, the display member 201 of FIG. 2, or the display 321 of FIG. 3), at least one processor 420 (e.g., the processor 120 of FIG. 1), and memory 430 (e.g., the memory 130 of FIG. 1 or memory 430 of FIG. 4). The memory 430 may store various types of data used by at least one component (e.g., the processor 420) of the electronic device 400.

According to an embodiment, the processor 420 may be implemented as circuitry (e.g., processing circuitry), such as an SoC or an IC. The processor 420 may include one or more processors. For example, the processor 420 may include a combination of one or more processors, such as a CPU, a GPU, an MPU, an AP, and a CP.

According to an embodiment, the memory 430 may include one or more memories. Instructions stored in the memory 430 may be stored in a single memory. The instructions stored in the memory 430 may be divided and stored in a plurality of memories. The instructions stored in the memory 430 may be individually or collectively executed by the processor 420 to cause the electronic device 400 to perform and/or control a method described with reference to FIGS. 2 to 14. The instructions stored in the memory 430 may be individually or collectively executed by a plurality of processors to cause the electronic device 400 to perform and/or control the method described with reference to FIGS. 2 to 14.

According to an embodiment, the display 410 may visually provide information to the outside (e.g., a user) of the electronic device 400. The display 410 may be configured to display an image or video. The display 410 may display a graphical user interface (GUI) of an app (or an application program) being executed. The display 410 may include, for example, a display, a hologram device, or a projector and control circuitry for controlling a corresponding one of the display, hologram device, and projector. The display 410 may include a touch sensor configured to sense a touch or a pressure sensor configured to measure the magnitude of force generated by the touch.

According to an embodiment, the processor 420 (e.g., an AP) may execute instructions by accessing the memory 430. The processor 420 may execute an image processing module 421, a gesture analysis module 422, a gaze analysis module 423, an automatic speech recognition (ASR) module 424, and/or a natural language understanding (NLU) module 425. For example, the image processing module 421, the gesture analysis module 422, the gaze analysis module 423, the ASR module 424, and/or the NLU module 425 may process a user input.

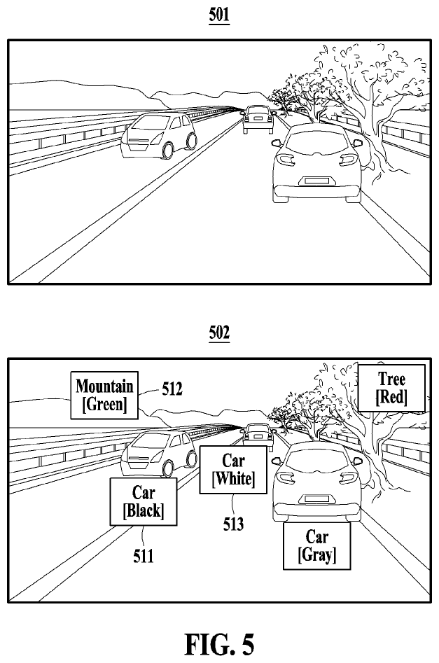

According to an embodiment, the image processing module 421 may generate image data by processing data collected from a camera (e.g., the camera module 180 of FIG. 1, the camera module 250 of FIG. 2, or the camera modules 311 to 316 of FIG. 3). The image data may be captured by a camera. The image processing module 421 may identify objects based on the image data. Object identification is described in detail with reference to FIG. 5.

According to an embodiment, the gesture analysis module 422 may analyze a gesture input of a user. For example, the gesture input of the user may be input to the electronic device 400 by a glove or a joystick. The gesture input of the user may be input to the electronic device 400 by a camera (e.g., the third camera module 255 of FIG. 2 or the camera modules 313 to 316 of FIG. 3). For example, the gesture analysis module 422 may perform user hand detection, user hand tracking, and user gesture (e.g., hand movement) recognition.

According to an embodiment, the gaze analysis module 423 may analyze a gaze input of the user. The gaze input of the user may be input to the electronic device 400 by a camera (e.g., the first camera module 251 of FIG. 2 or the camera modules 325 and 326 of FIG. 3). For example, the gaze analysis module 423 may recognize the trajectory of a gaze. For example, the gaze analysis module 423 may periodically or irregularly analyze information (e.g., trajectory information) related to the trajectory of the eyes or a gaze of the user.

According to an embodiment, the ASR module 424 and the NLU module 425 may process a voice input of the user. The ASR module 424 may convert data related to the voice input received from the electronic device 400 into text data. The NLU module 425 may analyze the converted text data to determine an action (e.g., a target object determination action and/or a target object control action) to be performed in response to the voice input (e.g., user utterance).

According to an embodiment, a user input may include first information and second information. The first information may be used to determine a target object, and the second information may be associated with at least one of display, recording, or sharing of a target object. For example, in the case of the voice input “zoom in on the cat in front,” the first information used to determine a target object may correspond to “the cat in front,” and the second information associated with a target object control action (e.g., displaying, recording, and/or sharing) may correspond to “zoom in.”

According to an embodiment, a user input for providing the first information and a user input for providing the second information may have different input types. For example, in the case of a gesture input (e.g., pointing at the cat in view with a finger) and a voice input (e.g., “zoom in on that”), the first information used to determine a target object may originate from the gesture input, while the second information associated with a target object control action (e.g., displaying, recording, and/or sharing) may originate from the voice input.

According to an embodiment, when the first information and/or the second information is insufficiently present in an input received by the electronic device 400 from the user, the electronic device 400 may request an additional input from the user. For example, when the electronic device 400 receives a gesture input (e.g., a zoom-in or zoom-out gesture made by pinching or spreading the thumb and index finger), the electronic device 400 may request an additional input from the user to determine which object to zoom in or out. In this case, the additional input of the user may, for example, be a voice input (e.g., “that cat”), a gesture input (e.g., pointing at the cat with a finger), or a gaze input (e.g., looking at the cat for a predetermined period of time).

FIG. 5 is a diagram illustrating object identification according to an embodiment.

Referring to FIG. 5, according to an embodiment, an electronic device (e.g., the electronic device 101 of FIG. 1, the electronic device 200 of FIG. 2, the electronic device 300 of FIG. 3, or the electronic device 400 of FIG. 4) may display, on a first area (e.g., entire area) of a display (e.g., the display module 160 of FIG. 1, the display member 201 of FIG. 2, the display 321 of FIG. 3, or the display 410 of FIG. 4), an image captured by a camera (e.g., the camera module 180 of FIG. 1, the camera module 250 of FIG. 2, or the camera modules 311 to 316 of FIG. 3). For example, what is displayed on the display 410 of the electronic device 400 may be a video. The electronic device 400 may display a video by sequentially displaying a plurality of images over time.

According to an embodiment, the electronic device 400 (e.g., the image processing module 421) may identify (e.g., 502) objects (e.g., 511, 512, and 513) included in a first area 501. The electronic device 400 may recognize objects (e.g., a tree, a car, a utility pole, and a person) in the first area 501. The electronic device 400 may classify the recognized objects. For example, the electronic device 400 may classify the recognized cars as a “white car,” a “black car,” or a “car number xxxx” (e.g., classifying based on features). For example, object recognition by the electronic device 400 may run in the background, or may be triggered by a user input. In addition, for example, object recognition may be performed by a server (e.g., the server 108 of FIG. 1) outside the electronic device.

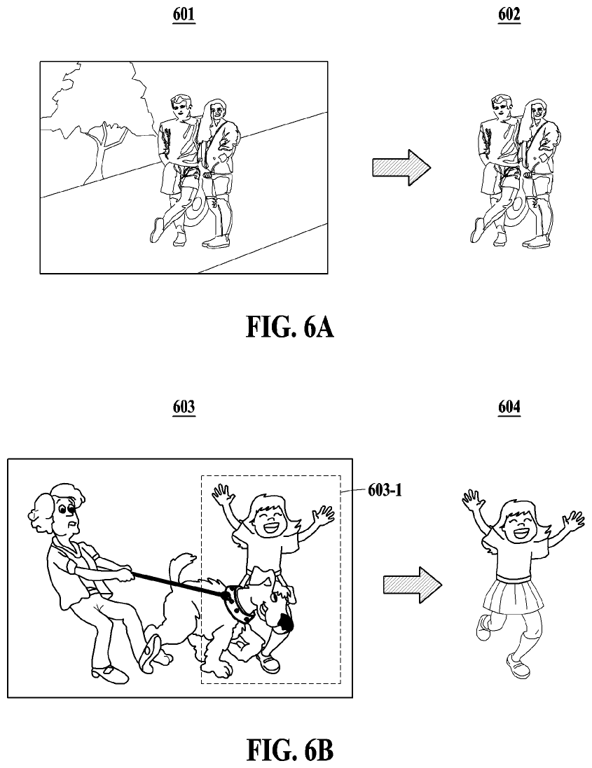

FIGS. 6A and 6B are diagrams illustrating determination of a target object according to an embodiment.

According to an embodiment, based on a user input including a gaze input, a voice input, and/or a gesture input, an electronic device (e.g., the electronic device 101 of FIG. 1, the electronic device 200 of FIG. 2, the electronic device 300 of FIG. 3, or the electronic device 400 of FIG. 4) may determine a target object that the user intends to control from among identified objects.

Referring to FIG. 6A, according to an embodiment, the electronic device 400 may obtain image data 602 corresponding to a target object (e.g., two people) in image data 601. The target object is not limited to one, and when there is a plurality of target objects, the electronic device 400 may treat the plurality of objects as one target object. For example, when obtaining the image data 602 corresponding to the target object (e.g., two people), the electronic device 400 may obtain the image data 602, which is natural image data, by blurring the outline of the target object.

Referring to FIG. 6B, according to an embodiment, the electronic device 400 may obtain image data 604 corresponding to a target object (e.g., a child) in image data 603. For example, when a portion of the target object (e.g., a child) is obscured by another object, the electronic device 400 may infer the obscured portion to obtain the image data 604, which is natural image data. For example, the electronic device 400 may infer a partial area through a generative model. The generative model may be embedded in the electronic device 400 or may be executed on a server (e.g., the server 108 of FIG. 1) outside the electronic device.

According to an embodiment, first information used to determine a target object may be obtained from a user input of a different type (e.g., a gaze input, a voice input, or a gesture input). For example, when a voice input (e.g., “cat”) and a gesture input (e.g., pointing at a striped cat) are input, the electronic device 400 may determine the striped cat as a target object.

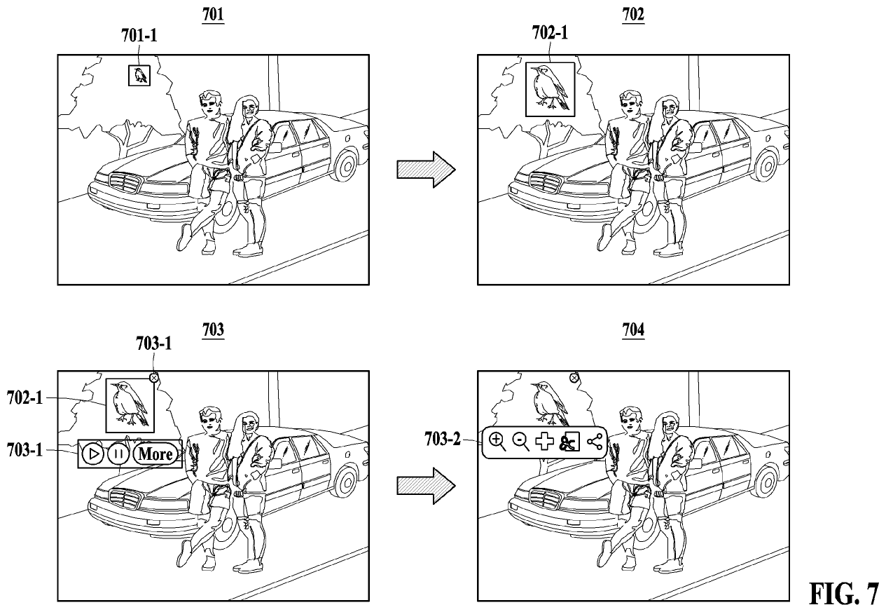

FIG. 7 is a diagram illustrating an object control interface for controlling a target object, according to an embodiment.

Referring to FIG. 7, according to an embodiment, an electronic device (e.g., the electronic device 101 of FIG. 1, the electronic device 200 of FIG. 2, the electronic device 300 of FIG. 3, or the electronic device 400 of FIG. 4) may display an object control interface for controlling a target object.

According to an embodiment, the electronic device 400 may display, on a first area (e.g., the entire area of a display 701) of the display 701 (e.g., the display module 160 of FIG. 1, the display member 201 of FIG. 2, the display 321 of FIG. 3, or the display 410 of FIG. 4), image data captured by a camera (e.g., the camera module 180 of FIG. 1, the camera module 250 of FIG. 2, or the camera modules 311 to 316 of FIG. 3). For example, what is displayed on the display 410 of the electronic device 400 may be a video. The electronic device 400 may display a video by sequentially displaying a plurality of images over time. The electronic device 400 may identify objects included in the first area (e.g., the entire area of the display 701). Based on a user input (e.g., a user input including a gaze input, a voice input, and/or a gesture input), the electronic device 400 may determine a target object 701-1 that a user intends to control from among the identified objects.

According to an embodiment, the electronic device 400 may display the target object 701-1 on a second area 702-1 of a display 702. The display 701 and the display 702 may be the same hardware (e.g., the display module 160 of FIG. 1, the display member 201 of FIG. 2, the display 321 of FIG. 3, or the display 410 of FIG. 4). Different reference numbers (e.g., 701, 702, 703, and 704) may be assigned to the display 410 to distinguish between different data shown on the display 410 at different points in time. For example, the second area 702-1 may be overlaid on the first area (e.g., the entire area of the display 702). For example, the second area 702-1 may be an area on which image data corresponding to the target object 701-1 is streamed (e.g., played in real time or transmitted dynamically). Streaming may be a method of transmitting data (e.g., image data) in fragments. The electronic device 400 may enhance the user experience by transmitting image data in real time through streaming. In an embodiment, the image data streamed on the second area 702-1 may include image data corresponding to the target object 701-1. What is displayed on the display 410 of the electronic device 400 may be a video. The electronic device 400 may display a video by sequentially displaying a plurality of images over time.

According to an embodiment, the electronic device 400 may display, on the display 703, an object control interface 703-1 associated with display, recording, and/or sharing of the target object 701-1. For example, the image data streamed on the second area 702-1 of the display 703 may be controlled based on a user input to the object control interface 703-1. In an embodiment, the object control interface 703-1 may be an element for performing a predetermined task or function in user experience (UX) and UI design. The object control interface 703-1 may be implemented in the form of a button, but embodiments are not limited thereto. For example, a probability that the object control interface 703-1 is touched may be visually realized through a three-dimensional (3D) design and/or a visual shadow that appears as if the 3D design and/or the visual shadow may be pressed. For example, the object control interface 703-1 may be operated through interactions such as clicking and touching. For example, in response to a user input to the object control interface 703-1 (e.g., a gaze input of staring at a part (e.g., a symbol) of an object control interface for a predetermined period of time, a voice input (e.g., an utterance) corresponding to the symbol of the object control interface, or a gesture input (e.g., a touch) to the symbol of the object control interface), the electronic device 400 may provide visual feedback (e.g., an indication that a clicked button is pressed) to the user. For example, the user may perform a predetermined task by interacting with the object control interface 703-1.

According to an embodiment, the object control interface 703-1 may include a symbol (e.g., a recording start symbol or a recording stop symbol) associated with the recording of a target object (e.g., image data corresponding to the target object). For example, the object control interface 703-1 may include a symbol (e.g., a cancel symbol) associated with the release of the target object 701-1. The object control interface 703-1 may include, for example, a symbol (e.g., a more symbol) that causes an additional interface.

According to an embodiment, the electronic device 400 may display an object control interface 703-2 on the display 704 based on a user input to a symbol (e.g., a more symbol) that causes an additional interface. For example, the object control interface 703-2 may include a symbol (e.g., a zoom-in symbol or a zoom-out symbol) associated with resizing a target object (e.g., a second area on which image data corresponding to the target object is streamed). For example, the object control interface 703-2 may include a symbol (e.g., a move symbol) associated with adjustment of the position of the target object (e.g., the second area on which image data corresponding to the target object is streamed). For example, the object control interface 703-2 may include a symbol (e.g., an edit symbol) associated with editing (e.g., editing via a camera app or editing via an edit app) of the target object (e.g., image data corresponding to the target object). For example, the object control interface 703-2 may include a symbol (e.g., a share symbol) associated with the sharing (e.g., sharing via a messenger app) of the target object (e.g., image data corresponding to the target object).

According to an embodiment, the electronic device 400 may update whether to record the target object (e.g., image data corresponding to the target object) based on a user input (e.g., a subsequent input) (e.g., an input for a recording start symbol or a recording stop symbol) to the object control interface 703-1. For example, the electronic device 400 may adjust the size of the target object (e.g., the second area on which image data corresponding to the target object is streamed) based on a user input (e.g., a subsequent input) (e.g., an input for a zoom-in symbol or a zoom-out symbol) to the object control interface 703-2. For example, the electronic device 400 may adjust the position of the target object (e.g., the second area on which image data corresponding to the target object is streamed) based on a user input (e.g., a subsequent input) (e.g., an input for a move symbol) to the object control interface 703-2. For example, the electronic device 400 may perform editing or sharing of the target object (e.g., image data corresponding to the target object) based on a user input (e.g., a subsequent input) (e.g., an input for an edit symbol or a share symbol) to the object control interface 703-2.

According to an embodiment, the electronic device 400 may release the target object 701-1 based on a user input (e.g., an input for a cancel symbol) to the object control interface 703-1. For example, image data of the target object 701-1 streamed on the second area 702-1 may be recorded within the electronic device 400 (e.g., the memory 430) from a point in time at which the target object 701-1 is determined. When the target object 701-1 is released, the recording of the target object (e.g., image data corresponding to the target object) may be stopped.

According to an embodiment, second information associated with the control (e.g., displaying (e.g., moving, zooming in, or zooming out), recording, sharing, or editing) of the target object may be obtained from a user input of a different type (e.g., a gaze input, a voice input, or a gesture input). For example, when a voice input (e.g., “zoom in”) and a gesture input (e.g., spreading the index finger and thumb) are input, the electronic device 400 may zoom in on the target object (e.g., the second area).

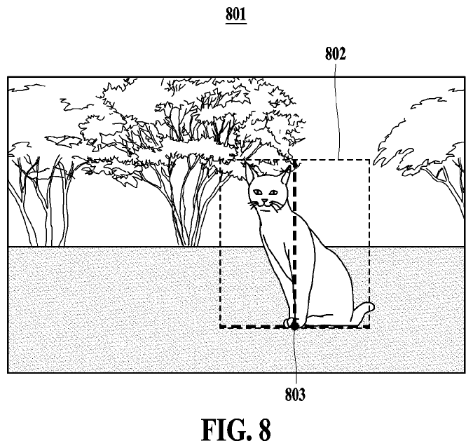

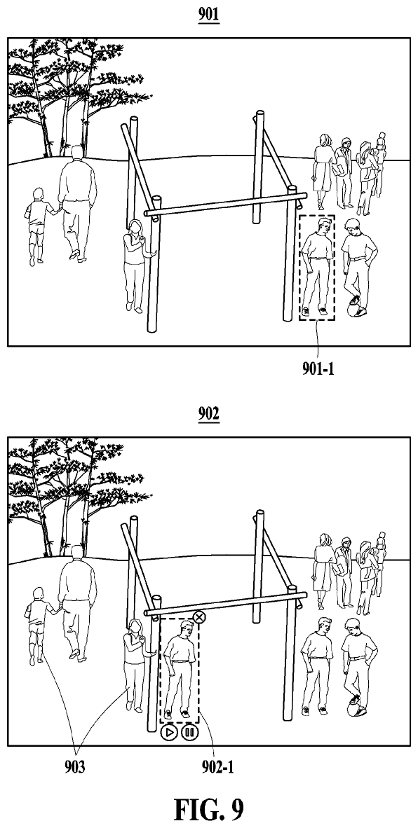

FIGS. 8 and 9 are diagrams illustrating a method of displaying a target object on a display based on a reference point, according to an embodiment.

Referring to FIG. 8, according to an embodiment, an electronic device (e.g., the electronic device 101 of FIG. 1, the electronic device 200 of FIG. 2, the electronic device 300 of FIG. 3, or the electronic device 400 of FIG. 4) may control a target object 802 on a display 801 based on a reference point 803 of the target object 802.

According to an embodiment, a reference point (e.g., 803) may be a point that serves as a reference for controlling a target object (e.g., 802). For example, the coordinates of the central pixel at the lowest position among the pixels included in the target object (e.g., 802) may be set as the reference point (e.g., 803) so that alignment with the real-world condition of gravity is satisfied. For example, based on the reference point, the target object may be zoomed in or zoomed out. If the reference point is positioned at the exact center of the target object, when the target object standing on the ground is zoomed out, the target object may be displayed as floating above the ground. If the reference point is positioned at the exact center of the target object, when the target object standing on the ground is zoomed in, a portion of the target object may be displayed as existing below the ground. The electronic device 400 may set, as the reference point of the target object, the coordinates of the central pixel at the lowest position among the pixels included in the target object, not the coordinates of the central pixel among the pixels included in the target object, so that even when the target object standing on the ground is zoomed in or zoomed out, the target object may be displayed as standing correctly on the ground. However, the setting of the reference point may vary depending on an environment (e.g., an AR environment, a VR environment, or an MR environment) provided by the electronic device 400. In an embodiment, the setting of the reference point may be changed according to user settings. For example, the coordinates corresponding to the center of gravity of an object may be set as the reference point.

According to an embodiment, the electronic device 400 may determine the reference point 803 of the target object 802. The electronic device 400 may determine the size and position of a second area based on a reference point and second information (e.g., second information associated with the control (e.g., displaying (e.g., moving, zooming in, or zooming out), recording, sharing, or editing) of a target object). The electronic device 400 may display the target object 802 (e.g., stream image data corresponding to the target object) on the second area having the determined size and position.

Referring to FIG. 9, according to an embodiment, the position of a second area 902-1 determined by the electronic device 400 based on a reference point of a target object 901-1 may be a position that does not overlap with other objects 903.

According to an embodiment, the electronic device 400 may display, on a first area (e.g., the entire area of a display 901) of the display 901 (e.g., the display module 160 of FIG. 1, the display member 201 of FIG. 2, the display 321 of FIG. 3, or the display 410 of FIG. 4), image data captured by a camera (e.g., the camera module 180 of FIG. 1, the camera module 250 of FIG. 2, or the camera modules 311 to 316 of FIG. 3). The electronic device 400 may identify objects included in the first area (e.g., the entire area of the display 901). Based on a user input (e.g., a user input including a gaze input, a voice input, and/or a gesture input), the electronic device 400 may determine a target object 901-1 that a user intends to control from among the identified objects. The electronic device 400 may determine the position of the determined second area 902-1 based on the reference point of the target object 901-1. For example, the position of the second area 902-1 may be a position that does not overlap with the other objects 903.

According to an embodiment, when an input received by the electronic device 400 from a user includes a voice input (e.g., “display on a secondary screen”), the electronic device 400 may determine the position of the second area 902-1 such that the target object 901-1 and the second area 902-1 are displayed together. The user may also track a target object (e.g., a target object streamed on the second area 902-1) that is extracted independently of the original target object (e.g., 901-1). The display 901 and the display 902 may be the same hardware (e.g., the display module 160 of FIG. 1, the display member 201 of FIG. 2, the display 321 of FIG. 3, or the display 410 of FIG. 4). Different reference numbers (e.g., 901 and 902) may be assigned to the display 410 to distinguish between different data shown on the display 410 at different points in time.

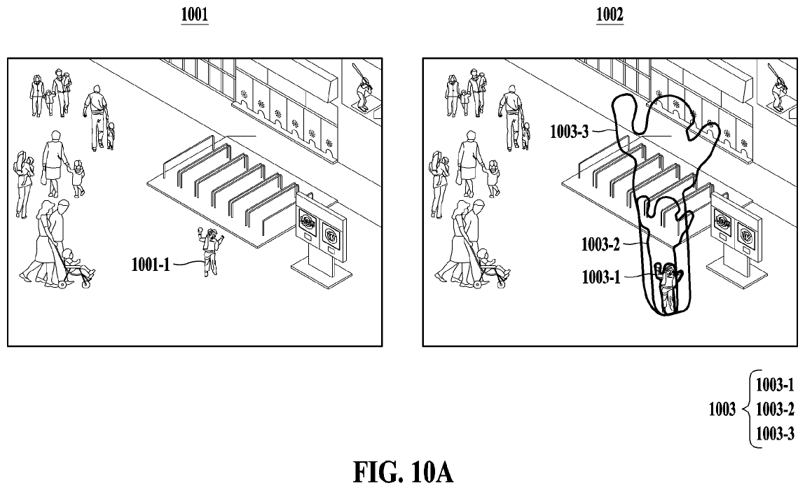

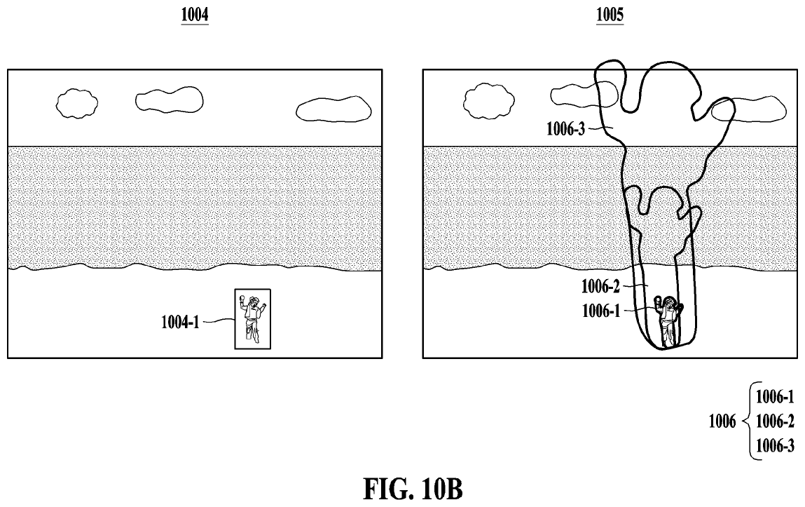

FIGS. 10A and 10B are diagrams illustrating a size selection guide for a target object, according to an embodiment.

Referring to FIG. 10A, according to an embodiment, an electronic device (e.g., the electronic device 101 of FIG. 1, the electronic device 200 of FIG. 2, the electronic device 300 of FIG. 3, or the electronic device 400 of FIG. 4) may provide a user with a size selection guide 1003 for a target object 1001-1.

According to an embodiment, the electronic device 400 may display, on a first area (e.g., the entire area of a display 1001) of the display 1001 (e.g., the display module 160 of FIG. 1, the display member 201 of FIG. 2, the display 321 of FIG. 3, or the display 410 of FIG. 4), image data captured by a camera (e.g., the camera module 180 of FIG. 1, the camera module 250 of FIG. 2, or the camera modules 311 to 316 of FIG. 3). The electronic device 400 may identify objects included in the first area (e.g., the entire area of the display 1001). Based on a user input (e.g., a user input including a gaze input, a voice input, and/or a gesture input), the electronic device 400 may determine a target object 1001-1 that the user intends to control from among the identified objects. For example, the electronic device 400 may receive a zoom-in input or a zoom-out input of the target object 1001-1 from the user.

According to an embodiment, the electronic device 400 may display the size selection guide 1003 for the target object 1001-1 on a first area (e.g., the entire area of a display 1002). The size selection guide 1003 may provide the user with an example of the size of the target object 1001-1 (e.g., the size of a second area). The size selection guide 1003 may include objects 1003-1 to 1003-3 having the same or similar shape as the target object 1001-1. The objects 1003-1 to 1003-3 may have the same or similar shape and may have different sizes. The electronic device 400 may determine the size of the target object 1001-1 (e.g., the size of the second area) based on a user input to the size selection guide 1003 (e.g., an input to any one of the objects 1003-1 to 1003-3).

Referring to FIG. 10A, according to an embodiment, when other objects, other than the target object 1001-1, are identified in the first area (e.g., the entire area of the display 1001), the electronic device 400 may generate the size selection guide 1003 based on the sizes of the other objects. For example, the electronic device 400 may use the largest object, the smallest object, and the closest object (e.g., the object closest to the target object) among the other objects.

Referring to FIG. 10B, according to an embodiment, when no other object, other than a target object 1004-1, is identified in the first area (e.g., the entire area of a display 1004), the electronic device 400 may generate a size selection guide 1006 based on a determined setting value. For example, when any one object (e.g., 1006-3) of the objects 1006-1 to 1006-3 generated according to a determined setting value exceeds the first area (e.g., the entire area of a display 1005), the object 1006-3 may be disabled. When the user adjusts his or her gaze (e.g., looks upward relative to a previous gaze) such that the disabled object 1006-3 no longer exceeds the first area (e.g., the entire area of the display 1005), the object 1006-3 may be enabled again.

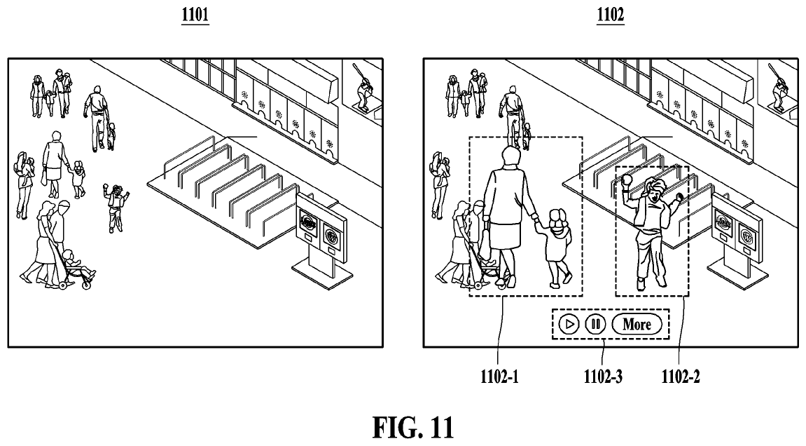

FIG. 11 is a diagram illustrating a case in which a plurality of target objects is provided, according to an embodiment.

Referring to FIG. 11, according to an embodiment, a target object may include a plurality of target objects. An electronic device (e.g., the electronic device 101 of FIG. 1, the electronic device 200 of FIG. 2, the electronic device 300 of FIG. 3, or the electronic device 400 of FIG. 4) may display an object control interface for controlling a plurality of target objects.

According to an embodiment, the electronic device 400 may display, on a first area (e.g., the entire area of a display 1101) of the display 1101 (e.g., the display module 160 of FIG. 1, the display member 201 of FIG. 2, the display 321 of FIG. 3, or the display 410 of FIG. 4), image data captured by a camera (e.g., the camera module 180 of FIG. 1, the camera module 250 of FIG. 2, or the camera modules 311 to 316 of FIG. 3). The electronic device 400 may identify objects included in the first area (e.g., the entire area of the display 1101). Based on a user input (e.g., a user input including a gaze input, a voice input, and/or a gesture input), the electronic device 400 may determine a plurality of target objects that a user intends to control from among the identified objects.

According to an embodiment, the electronic device 400 may display the plurality of target objects on a plurality of second areas 1102-1 and 1102-2 of a display 1102. Image data corresponding to any one of the plurality of target objects may be streamed on each of the plurality of second areas 1102-1 and 1102-2. The image data streamed on the plurality of second areas 1102-1 and 1102-2 may be controlled based on a user input to an object control interface 1102-3. Referring to FIG. 11, the object control interface 1102-3 for controlling the plurality of target objects is illustrated as being one. However, embodiments are not limited thereto. The electronic device 400 may display a plurality of object control interfaces for controlling respective target objects.

According to an embodiment, the positions of the plurality of second areas 1102-1 and 1102-2 may be determined so as not to overlap with other objects (e.g., other objects identified in a first area) on the first area (e.g., the entire area of the display 1102).

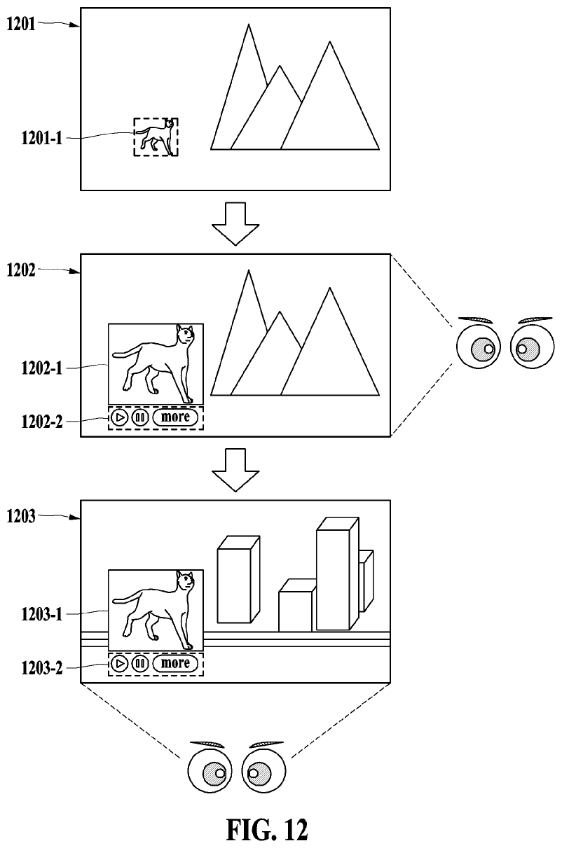

FIG. 12 is a diagram illustrating a case in which a plurality of cameras is provided, according to an embodiment.

Referring to FIG. 12, according to an embodiment, a target object may be tracked depending on the number of cameras. An electronic device (e.g., the electronic device 101 of FIG. 1, the electronic device 200 of FIG. 2, the electronic device 300 of FIG. 3, or the electronic device 400 of FIG. 4) may track a target object when a plurality of cameras is provided.

According to an embodiment, the electronic device 400 may display, on a first area (e.g., the entire area of a display 1201) of the display 1201 (e.g., the display module 160 of FIG. 1, the display member 201 of FIG. 2, the display 321 of FIG. 3, or the display 410 of FIG. 4), image data captured by a camera (e.g., the camera module 180 of FIG. 1, the camera module 250 of FIG. 2, or the camera modules 311 to 316 of FIG. 3). The electronic device 400 may identify objects included in the first area (e.g., the entire area of the display 1201). Based on a user input (e.g., a user input including a gaze input, a voice input, and/or a gesture input), the electronic device 400 may determine a target object 1201-1 that a user intends to control from among the identified objects.

According to an embodiment, the electronic device 400 may display the target object 1201-1 on a second area 1202-1 of a display 1202. The electronic device 400 may also display an object control interface 1202-2 synchronized with image data streamed on the second area 1202-1. The image data streamed on the second area 1202-1 may be controlled based on a user input to the object control interface 1202-2.

According to an embodiment, the electronic device 400 may recognize the movement of the gaze (or head) of the user. Even when a target object is not identified in image data captured by a camera due to the movement of the gaze (or head) of the user, the electronic device 400 may display the target object 1201-1 on a second area 1203-1 of a display 1203. For example, the electronic device 400 may display an object control interface 1203-2 synchronized with image data streamed on the second area 1203-1. The image data streamed on the second area 1203-1 may be controlled based on a user input to the object control interface 1203-2. The target object may be tracked by any one of a plurality of cameras. When the electronic device 400 includes a plurality of cameras, image data corresponding to the target object may be continuously streamed on the second area 1203-1.

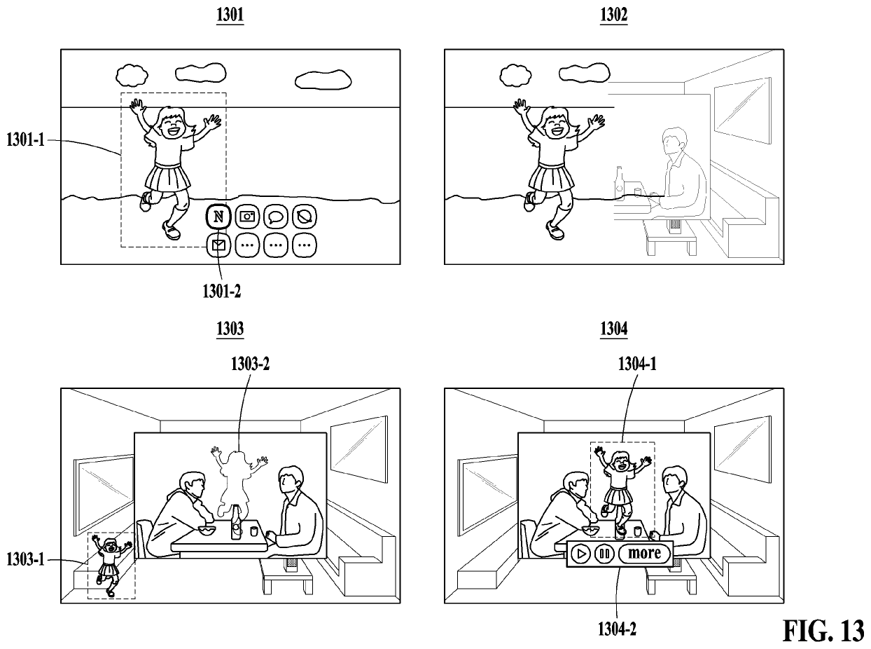

FIG. 13 is a diagram illustrating a case in which an environment in which a target object is displayed changes, according to an embodiment.

Referring to FIG. 13, according to an embodiment, an environment in which a target object is displayed may change. An electronic device 400 (e.g., the electronic device 101 of FIG. 1, the electronic device 200 of FIG. 2, or the electronic device 300 of FIG. 3) may display a target object 1301-1 on a second area of a display 1301 (e.g., the display module 160 of FIG. 1, the display member 201 of FIG. 2, the display 321 of FIG. 3, or the display 410 of FIG. 4). The electronic device 400 may display, on the display 1301, a user interface (e.g., 1301-2) that is unrelated to the target object 1301-1. The electronic device 400 may receive a user input to the user interface 1301-2.

According to an embodiment, the electronic device 400 may change an environment displayed on the display 1302 based on the user input to the user interface 1301-2. Different reference numbers (e.g., 1301, 1302, 1303, and 1304) may be assigned to the display 410 to distinguish between different data shown on the display 410 at different points in time. The electronic device 400 may display an AR environment on the display 1301. For example, the electronic device 400 may display, on a first area (e.g., the entire area) of the display 1301, image data captured by a camera (e.g., the camera module 180 of FIG. 1, the camera module 250 of FIG. 2, or the camera modules 311 to 316 of FIG. 3) and may display, on a second area of the display 1301, a result of processing (a result of zooming in) at least a portion (e.g., image data corresponding to the target object 1301-1) of the image data captured by the camera. The electronic device 400 may switch the environment displayed on the display 1302 from the AR environment to a VR environment, based on the user input to the user interface 1301-2.

According to an embodiment, the electronic device 400 may display the VR environment on a display 1303. The electronic device 400 may display the target object 1301-1 on a second area 1303-1 of the display 1303 even within the VR environment. As the environment displayed by the electronic device 400 on the display 1303 changes, data (e.g., real-world position information-based data) (e.g., reference point information) used in the AR environment may be lost. For example, a second area 1303-2 on which the electronic device 400 displays the target object 1301-1 may be moved to the lower left side of the display 1303. The second area of the display 1301 on which the target object 1301-1 is displayed may be displayed as an afterimage (e.g., 1303-2) on the display 1303.

According to an embodiment, based on a user input to the afterimage 1303-2, the electronic device 400 may move the second area on which the target object 1301-1 is displayed on the display 1304 (e.g., 1304-1). The electronic device 400 may display the target object 1301-1 on the second area 1304-1 of the display 1304. The electronic device 400 may also display an object control interface 1304-2 synchronized with image data streamed on the second area 1304-1. The image data streamed on the second area 1304-1 may be controlled based on a user input to the object control interface 1304-2.

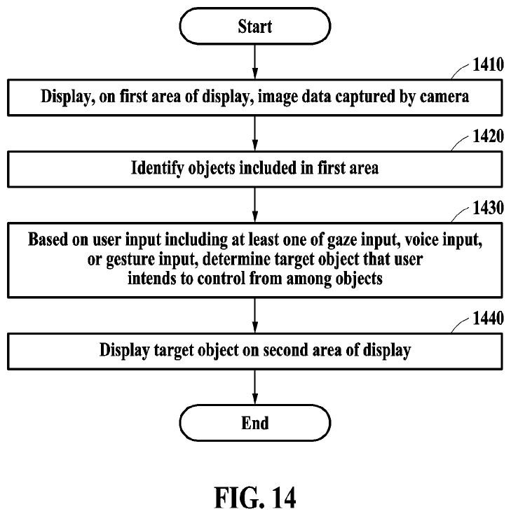

FIG. 14 is a flowchart of an operating method of an electronic device, according to an embodiment.

Referring to FIG. 14, operations 1410 to 1440 may be performed sequentially but not necessarily. For example, the order of operations 1410 to 1440 may be changed, and at least two operations thereof may be performed in parallel.

In operation 1410, an electronic device (e.g., the electronic device 101 of FIG. 1, the electronic device 200 of FIG. 2, the electronic device 300 of FIG. 3, or the electronic device 400 of FIG. 4) according to an embodiment may display, on a first area of a display (e.g., the display module 160 of FIG. 1, the display member 201 of FIG. 2, the display 321 of FIG. 3, or the display 410 of FIG. 4), image data captured by a camera (e.g., the camera module 180 of FIG. 1, the camera module 250 of FIG. 2, or the camera modules 311 to 316 of FIG. 3).

In operation 1420, the electronic device according to an embodiment may identify objects included in the first area.

In operation 1430, the electronic device according to an embodiment may determine a target object that a user intends to control from among the objects, based on a user input including at least one of a gaze input, a voice input, or a gesture input.

In operation 1440, the electronic device according to an embodiment may display the target object on a second area of the display. For example, the second area may be overlaid on the first area. For example, the second area may be an area on which image data corresponding to the target object is streamed. For example, the image data streamed on the second area may be controlled based on a user input to an object control interface associated with display, recording, and/or sharing of the target object.

An operating method of an electronic device (e.g., the electronic device 101 of FIG. 1, the electronic device 200 of FIG. 2, the electronic device 300 of FIG. 3, or the electronic device 400 of FIG. 4) according to an embodiment may include displaying, on a first area of a display (e.g., the display module 160 of FIG. 1, the display member 201 of FIG. 2, the display 321 of FIG. 3, or the display 410 of FIG. 4), image data captured by a camera (e.g., the camera module 180 of FIG. 1, the camera module 250 of FIG. 2, or the camera modules 311 to 316). The operating method may include identifying objects included in the first area. The operating method may include determining a target object that a user intends to control from among the objects, based on a user input including at least one of a gaze input, a voice input, or a gesture input. The operating method may include displaying the target object on a second area of the display. The second area may be overlaid on the first area. The second area may be an area on which image data corresponding to the target object is streamed. The image data streamed on the second area may be controlled based on the user input to an object control interface of the target object.

According to an embodiment, the user input may include at least one of first information used to determine the target object or second information associated with at least one of display, recording, or sharing of the target object. The user input for providing the first information and the user input for providing the second information may have different input types.

According to an embodiment, the user input comprises second information associated with at least one of display, recording, or sharing of the target object. the displaying of the target object on the second area may include determining a reference point of the target object. The displaying of the target object on the second area may include determining the size and position of the second area based on the reference point and the second information. The displaying of the target object on the second area may include displaying the target object on the second area having the determined size and position. The reference point may correspond to the coordinates of the central pixel at the lowest position among the pixels included in the target object.

According to an embodiment, the determining of the size and position of the second area may include displaying a size selection guide for the target object on the first area. The determining of the size and position of the second area may include determining the size of the second area based on the user input to the size selection guide.

According to an embodiment, when another object, other than the target object, is identified in the first area, the size selection guide may be generated based on the size of the other object. When no other object, other than the target object, is identified in the first area, the size selection guide may be generated based on a predetermined setting value.

According to an embodiment, the position of the second area may be determined so as not to overlap with the other object in the first area, based on information regarding the other object, other than the target object, identified in the first area.

According to an embodiment, the target object may include a plurality of target objects. The second area may include a plurality of second areas on which image data corresponding to any one of the plurality of target objects is streamed. The positions of the plurality of second areas may be determined so as not to overlap with another object in the first area.

According to an embodiment, the image data streamed on the second area may be recorded in the electronic device upon the target object being determined.

According to an embodiment, when there is a single camera, the target object may not be displayed on the second area at which the target object is not identified in image data captured by the camera. When there is a plurality of cameras, the target object may be tracked by any one of the plurality of cameras, and the image data corresponding to the target object may be continuously streamed on the second area.

According to an embodiment, the operating method may include adjusting at least one of the position or size of the second area based on a subsequent input of the user to the object control interface. The operating method may include updating whether recording is to be performed for the second area based on the subsequent input. The operating method may include performing sharing for the second area based on the subsequent input. The object control interface may be associated with display, recording, and sharing of the target object.

An electronic device (e.g., the electronic device 101 of FIG. 1, the electronic device 200 of FIG. 2, the electronic device 300 of FIG. 3, the electronic device 400 of FIG. 4) according to an embodiment may include a display (e.g., the display module 160 of FIG. 1, the display member 201 of FIG. 2, the display 321 of FIG. 3, or the display 410 of FIG. 4). The electronic device may include one or more processors (e.g., the processor 120 of FIG. 1 or the processor 420 of FIG. 4). The electronic device may include memory (e.g., the memory 130 of FIG. 1 or the memory 430 of FIG. 4) storing instructions. When executed by the one or more processors individually or collectively, the instructions may cause the electronic device to display, on a first area, image data captured by a camera. When executed by the one or more processors individually or collectively, the instructions may cause the electronic device to identify objects included in the first area. When executed by the one or more processors individually or collectively, the instructions may cause the electronic device to, based on a user input including at least one of a gaze input, a voice input, or a gesture input, determine a target object that a user intends to control from among the objects. When executed by the one or more processors individually or collectively, the instructions may cause the electronic device to display the target object on a second area of the display. The second area may be overlaid on the first area. The second area may be an area on which image data corresponding to the target object is streamed. The image data streamed on the second area may be controlled based on a user input to an object control interface of the target object.

According to an embodiment, the user input may include at least one of first information used to determine the target object or second information associated with at least one of display, recording, or sharing of the target object. A user input for providing the first information and a user input for providing the second information may have different input types.

According to an embodiment, the image data streamed on the second area may be recorded in the electronic device upon the target object being determined.

According to an embodiment, when there is a single camera, the target object may not be displayed on the second area at a point in time at which the target object is not identified in image data captured by the camera. When there is a plurality of cameras, the target object may be tracked by any one of the plurality of cameras, and the image data corresponding to the target object may be continuously streamed on the second area.

According to an embodiment, when executed by the one or more processors individually or collectively, the instructions may cause the electronic device to determine a reference point of the target object. When executed by the one or more processors individually or collectively, the instructions may cause the electronic device to determine the size and position of the second area based on the reference point and the second information. When executed by the one or more processors individually or collectively, the instructions may cause the electronic device to display the target object on the second area having the determined size and position. The reference point may correspond to the coordinates of the central pixel at the lowest position among the pixels included in the target object.

According to an embodiment, when executed by the one or more processors individually or collectively, the instructions may cause the electronic device to display a size selection guide for the target object on the first area. When executed by the one or more processors individually or collectively, the instructions may cause the electronic device to determine the size of the second area based on an input of the user to the size selection guide.

According to an embodiment, when another object, other than the target object, is identified in the first area, the size selection guide may be generated based on the size of the other object. When no other object, other than the target object, is identified in the first area, the size selection guide may be generated based on a predetermined setting value.

According to an embodiment, the position of the second area may be determined so as not to overlap with the other object in the first area, based on information regarding the other object, other than the target object, identified in the first area.

According to an embodiment, the target object may include a plurality of target objects. The second area may include a plurality of second areas on which image data corresponding to any one of the plurality of target objects is streamed. The positions of the plurality of second areas may be determined so as not to overlap with another object in the first area.

The electronic device according to various embodiments may be one of various types of electronic devices. The electronic device may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., program) including one or more instructions that are stored in a storage medium (e.g., internal memory or external memory) that is readable by a machine (e.g., electronic device). For example, a processor (e.g., processor) of the machine (e.g., electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. A machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An operating method of an electronic device, the operating method comprising:
displaying, on a first area of a display, image data captured by a camera;
identifying objects comprised in the first area;
based on a user input comprising at least one of a gaze input, a voice input, or a gesture input, determining a target object that a user intends to control from among the objects; and
displaying the target object on a second area of the display,
wherein the second area is overlaid on the first area,
wherein the second area is an area on which image data corresponding to the target object is streamed, and
wherein the image data streamed on the second area is controlled based on the user input to an object control interface of the target object.

2. The operating method of claim 1, wherein the user input comprises at least one of:
first information used to determine the target object; or
second information associated with at least one of display, recording, or sharing of the target object, and
wherein the user input for providing the first information and the user input for providing the second information have different input types.

3. The operating method of claim 1, wherein the user input comprises second information associated with at least one of display, recording, or sharing of the target object, and
wherein the displaying of the target object on the second area comprises:
determining a reference point of the target object;
determining a size and a position of the second area based on the reference point and second information; and
displaying the target object on the second area having the determined size and position, and
wherein the reference point corresponds to coordinates of a central pixel at a lowest position among pixels comprised in the target object.

4. The operating method of claim 3, wherein the determining of the size and the position of the second area comprises:
displaying a size selection guide for the target object on the first area; and
determining the size of the second area based on an input of the user to the size selection guide.

5. The operating method of claim 4, wherein:
based on another object, other than the target object, being identified in the first area, the size selection guide is generated based on a size of the other object, and
based on no other object, other than the target object, being identified in the first area, the size selection guide is generated based on a predetermined setting value.

6. The operating method of claim 1, wherein, based on information regarding another object, other than the target object, being identified in the first area, the position of the second area is determined so as not to overlap with the other object in the first area.

7. The operating method of claim 1, wherein the target object comprises a plurality of target objects,
wherein the second area comprises a plurality of second areas on which image data corresponding to any one of the plurality of target objects is streamed, and
wherein positions of the plurality of second areas are determined so as not to overlap with objects, other than the plurality of target objects, in the first area.

8. The operating method of claim 1, wherein the image data streamed on the second area is recorded in the electronic device based on the target object being determined.

9. The operating method of claim 1, wherein based on the camera being a single camera, the target object is not displayed on the second area while the target object is not identified in the image data captured by the camera, and
based on the camera comprising a plurality of cameras, the target object is tracked by any one of the plurality of cameras, such that image data corresponding to the target object is continuously streamed on the second area.

10. The operating method of claim 1, further comprising at least one of:
adjusting at least one of a position or a size of the second area based on a subsequent input of the user to the object control interface;
updating whether recording is to be performed for the second area based on the subsequent input; or
performing sharing for the second area based on the subsequent input, and
wherein the object control interface is associated with display, recording, and sharing of the target object.

11. An electronic device comprising:
a display;
one or more processors; and
memory storing instructions,
wherein the instructions, when executed by the one or more processors individually or collectively, cause the electronic device to:
display, on a first area of the display, image data captured by a camera;
identify objects comprised in the first area;
based on a user input comprising at least one of a gaze input, a voice input, or a gesture input, determine a target object that a user intends to control from among the objects; and
display the target object on a second area of the display,
wherein the second area is overlaid on the first area,
wherein the second area is an area on which image data corresponding to the target object is streamed, and
wherein the image data streamed on the second area is controlled based on the user input to an object control interface of the target object.

12. The electronic device of claim 11, wherein the user input comprises at least one of:
first information used to determine the target object; or
second information associated with at least one of display, recording, or sharing of the target object, and
wherein the user input for providing the first information and the user input for providing the second information have different input types.

13. The electronic device of claim 11, wherein the image data streamed on the second area is recorded in the electronic device based on the target object being determined.

14. The electronic device of claim 11, wherein based on the camera being a single camera, the target object is not displayed on the second area while the target object is not identified in image data captured by the camera, and
based on the camera comprising a plurality of cameras, the target object is tracked by any one of the plurality of cameras, such that image data corresponding to the target object is continuously streamed on the second area.

15. The electronic device of claim 11, wherein the user input comprises second information associated with at least one of display, recording, or sharing of the target object, and
wherein the instructions, when executed by the one or more processors individually or collectively, cause the electronic device to:
determine a reference point of the target object;
determine a size and a position of the second area based on the reference point and the second information; and
display the target object on the second area having the determined size and position, and
wherein the reference point corresponds to coordinates of a central pixel at a lowest position among pixels comprised in the target object.

16. The electronic device of claim 15,
wherein the instructions, when executed by the one or more processors individually or collectively, cause the electronic device to:
display a size selection guide for the target object on the first area; and
determine the size of the second area based on an input of the user to the size selection guide.

17. The electronic device of claim 16, wherein:
based on another object, other than the target object, being identified in the first area, the size selection guide is generated based on a size of the other object, and
based on no other object, other than the target object, being identified in the first area, the size selection guide is generated based on a predetermined setting value.

18. The electronic device of claim 11, wherein:
wherein, based on information regarding another object, other than the target object, being identified in the first area, the position of the second area is determined so as not to overlap with the other object in the first area.

19. The electronic device of claim 11, wherein the target object comprises a plurality of target objects,
wherein the second area comprises a plurality of second areas on which image data corresponding to any one of the plurality of target objects is streamed, and
wherein positions of the plurality of second areas may be determined so as not to overlap with another object in the first area.

20. A non-transitory computer-readable storage medium storing instructions that, when executed by a processor, cause the processor to perform the method of claim 1.
